(19) United States
(12) Patent Application Publication
(10) Pub. No.: US 2024/0297599 A1
(43) Pub. Date: Sep. 5, 2024

(54) Resonance-Tracking Broadband Energy Harvester

(71) Applicant: North Carolina State University, Raleigh, NC (US)

(72) Inventors: Edmon Perkins, Raleigh, NC (US); XiaoFu Li, Raleigh, NC (US)

(21) Appl. No.: 18/594,514

(22) Filed: Mar. 4, 2024

Related U.S. Application Data
(60) Provisional application No. 63/449,393, filed on Mar. 2, 2023.

(51) Int. Cl. H02N 2/18; G05D 3/12

(52) U.S. Cl. CPC H02N 2/188; G05D 3/12

(57) ABSTRACT

Various examples are provided related to resonance tracking broadband energy harvesting. In one example, a resonance tracking energy harvester includes a pendulum adaptive frequency oscillator including an adjustable pendulum rod and control circuitry that can adjust a length of the adjustable pendulum rod in response to a sensed forcing frequency. In another example, a method of resonance tracking energy harvesting, includes sensing a forcing frequency applied to a pendulum adaptive frequency oscillator comprising an adjustable pendulum rod; and adjusting a length of the adjustable pendulum rod in response to the sensed forcing frequency. Oscillation and/or vibration of the pendulum adaptive frequency oscillator can be converted.

### CROSS REFERENCE TO RELATED APPLICATIONS

This application claims priority to, and the benefit of, U.S. provisional application entitled “Resonance-Tracking Broadband Energy Harvester” having Ser. No. 63/449,393, filed Mar. 2, 2023, which is hereby incorporated by reference in its entirety.

### STATEMENT REGARDING FEDERALLY SPONSORED RESEARCH OR DEVELOPMENT

This invention was made with government support under W911NF-20-1-0336 awarded by the Army Research Laboratory—Army Research Office. The government has certain rights in the invention.

### BACKGROUND

Pendulums have been studied for millennia, and they appear in many different physical contexts. A simple mechanical pendulum can be created from a single mass that is constrained to rotate about a pivot point. The simple pendulum is easy to fabricate, but it exhibits complex dynamics because of its nonlinear equations of motion. More complex pendulums can be created. For this reason, the mechanical pendulum is a popular system to benchmark nonlinear controls. Chaos in pendular systems (especially the double pendulum) has been studied extensively.

### SUMMARY

Aspects of the present disclosure are related to resonance tracking broadband energy harvesting. In one aspect, among others, a resonance tracking energy harvester comprises a pendulum adaptive frequency oscillator comprising an adjustable pendulum rod; and control circuitry configured to adjust a length of the adjustable pendulum rod in response to a sensed forcing frequency. In one or more aspects, the adjustable pendulum rod can extend above a pivot point of the pendulum adaptive frequency oscillator. The pendulum adaptive frequency oscillator can comprise an actuator configured to adjust the length of the adjustable pendulum rod above the pivot point. The actuator can be a stepper motor configured to advance or retract the adjustable pendulum arm. The control circuitry can comprise a stepper motor controller. The adjustable pendulum rod can comprise a weight at a distal end above the pivot point.

In various aspects, the pendulum adaptive frequency oscillator can comprise a rotary encoder configured to measure angular displacement of the pendulum adaptive frequency oscillator. The length of the adjustable pendulum rod can be adjusted for resonant operation at the sensed forcing frequency. The length of the adjustable pendulum rod can be adjusted in response to a change in the sensed forcing frequency. Oscillation of the pendulum adaptive frequency oscillator can be converted to electrical energy. The electrical energy can be harvested via one or more piezoelectric elements. A laser displacement sensor can detect the sensed forcing frequency.

In another aspect, a method of resonance tracking energy harvesting comprises sensing a forcing frequency applied to a pendulum adaptive frequency oscillator comprising an adjustable pendulum rod; and adjusting a length of the adjustable pendulum rod in response to the sensed forcing frequency. In one or more aspects, the length of the adjustable pendulum rod can be adjusted by an actuator. The actuator can be a stepper motor configured to advance or retract the adjustable pendulum arm. Adjusting the length of the adjustable pendulum rod can comprise extending the adjustable pendulum rod above a pivot point of the pendulum adaptive frequency oscillator. The adjustable pendulum rod can comprise a weight at a distal end above the pivot point. The method can comprise converting oscillation of the pendulum adaptive frequency oscillator to electrical energy. The method can comprise converting vibrational energy of the pendulum adaptive frequency oscillator to electrical energy.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a pendulum with horizontal forcing, in accordance with various embodiments of the present disclosure.

FIGS. 2A and 2B illustrate how the pendulum acts as a linear oscillator for small oscillations, in accordance with various embodiments of the present disclosure.

FIGS. 3A and 3B illustrate how the pendulum acts as a softening Duffing oscillator for large oscillations, in accordance with various embodiments of the present disclosure.

FIGS. 4A and 4B illustrate an example of a pendulum adaptive frequency oscillator, in accordance with various embodiments of the present disclosure.

FIGS. 5A and 5B illustrate a model of the pendulum adaptive frequency oscillator, in accordance with various embodiments of the present disclosure.

FIGS. 6A and 6B illustrate an example of frequency response of a non-adaptive pendulum, in accordance with various embodiments of the present disclosure.

FIG. 7 illustrates an example of a pendulum's linear natural frequency characteristic, in accordance with various embodiments of the present disclosure.

FIG. 8 illustrates time history of an example of the pendulum adaptive frequency oscillator with an external forcing function, in accordance with various embodiments of the present disclosure.

FIGS. 9A and 9B illustrate an example of a forcing function sweep preformed on the pendulum adaptive frequency oscillator, in accordance with various embodiments of the present disclosure.

### DETAILED DESCRIPTION

Disclosed herein are various examples related to resonance tracking broadband energy harvesting. Reference will now be made in detail to the description of the embodiments as illustrated in the drawings, wherein like reference numbers indicate like parts throughout the several views.

Adaptive frequency oscillators are a subset of nonlinear oscillators that can learn and store information in plastic, dynamic states. Some of these oscillators can be engineered to become resonance-tracking devices, which can be used as broadband energy harvesters. Vibratory energy harvesters typically can either harvest broadband frequencies with a fairly low amplitude motion or harvest narrowband frequencies with a large amplitude motion. Since vibratory energy harvesters theoretically work best if they vibrate at large amplitude over a large range of frequencies, a resonance-tracking broadband energy harvester offers an ideal solution. A pendulum adaptive frequency oscillator has been experimentally constructed, which tracks a resonance condition to maintain large amplitude vibrations over broadband frequencies. Other types of physical implementations of resonance-tracking broadband energy harvesters can be constructed based on the same principle including, e.g., vortex-induced vibration energy harvesters.

Linear, static energy harvesters work well, if there is a specific, known frequency component in the environment. For instance, if an engine produces a 100 Hz signal, a linear, static energy harvester can be designed to amplify and harvest this specific signal. However, if the 100 Hz signal shifts to 110 Hz, the linear, static energy harvester will have severely degraded operation. Nonlinear, static energy harvesters work best for broadband frequencies, but they underperform linear, static energy harvesters if there is a predominant frequency.

Adaptive frequency oscillators are a subset of nonlinear oscillators that can learn and store information in plastic, dynamic states. Some of these oscillators can be engineered to become resonance-tracking devices, which can be used as broadband energy harvesters. A pendulum adaptive frequency oscillator has been experimentally constructed, which tracks a resonance condition to maintain large amplitude vibrations over broadband frequencies. Notably, this pendulum adaptive frequency oscillator does not follow the linear natural frequency when the forcing amplitude is large, but it instead tracks the nonlinear resonance condition.

Vibratory energy harvesters should vibrate with large amplitude to harvest the most energy. Typically, vibratory energy harvesters can either harvest broadband frequencies with fairly low amplitude motion or harvest narrowband frequencies with large amplitude motion. Broadband devices can be constructed by including a static nonlinearity, such as a bistable potential well. These broadband devices typically underperform narrowband harvesters if there is a specific predominant frequency. On the other hand, narrowband frequency harvesters work best when the quality factor is high to ensure amplification of the external signal. However, if the external signal's frequency shifts slightly, it can fall out of the amplification region of the harvester.

To circumvent the tradeoff between broadband harvesting and signal amplification, the resonance-tracking broadband energy harvester is ideal. The resonance-tracking broadband energy harvester offers a large amplitude over a large range of frequencies. Furthermore, the pendulum adaptive frequency oscillator, which is an example of a resonance-tracking broadband energy harvester, utilizes the nonlinearity of the pendulum's intrinsic dynamics to further amplify the external signal's predominant frequency. The resonance-tracking broadband energy harvester could be implemented in many different configurations. This appears to be the first time that adaptive oscillators have been proposed as a dynamic energy harvester, which adaptively learns and tracks the predominant vibratory energy source in the environment.

Pendulums can also be used as energy harvesters, and several methods have been proposed. A ratcheting flywheel mechanism and mechanical motion rectifier can be used to harvest rotational oscillations, as well as rotational modes without a gearbox. By incorporating elasticity into the pendulum's rod, a piezoelectric spring pendulum can be used for both single pendulums and double pendulums. In these implementations, the piezoelectric elements harvest vibrations from the rod. In another configuration, the rotation point of a 3D pendulum can be fixed to the end of a cantilever beam, which contains a piezoelectric patch. Resonances between the pendulum and cantilever can be exploited to harvest more vibratory energy.

Unlike other types of vibratory control and phase locked loops, adaptive oscillators use plastic dynamic states to both learn and store information from an external stimuli. For instance, adaptive frequency oscillators can synchronize their own frequency to that of an external stimuli without the aid of any pre- and post-processing of system response, and the frequency adaptation is embedded directly into the system's dynamics. Adaptive oscillators can use a Hebbian learning rule, which was inspired by neuronal systems' ability to synchronize. There are many viable applications of adaptive frequency oscillators. They have beer, used as central pattern generators for robotics locomotion control. These oscillators, because of the nature of their frequency adaptation, can also be used as adaptive controllers to find and match the natural frequency for the purpose of increasing energy-efficiency of a resultant gait. Adaptive oscillators may also be used as analog frequency analyzers. Related to adaptive oscillators, a frequency self-tracking cantilever beam was studied and achieved by sliding an attached mass without any active control involvement; however, this type of architecture relies on higher order modes. Their capability has been tested experimentally with a Hopf adaptive oscillator circuit, and the effects of noise on a Hopf adaptive oscillator was studied experimentally, numerically, and analytically using the full Fokker-Planck equation.

Limit cycle oscillators, such as the Hopf oscillator or the van der Pol oscillator, have been often used as the base for adaptive oscillators. However, a pendulum has not been previously used as the base of an adaptive oscillator. Here, a mechanical pendulum adaptive oscillator is described and experimentally tested. The length of the pendulum's rod is used to store the frequency of the external force. This system can be used as a smart energy harvesting system. The equations of motion of the pendulum adaptive frequency oscillator are first described and numerical results are presented. Next, an experimental pendulum adaptive frequency oscillator setup is discussed. The experimental results are presented and discussed.

### Equations of Motion

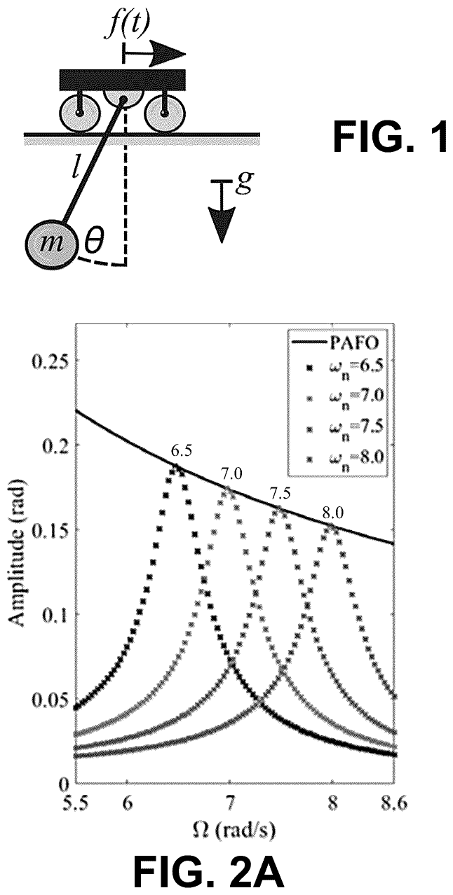

FIG. 1 illustrates an example of a horizontally forced pendulum. The pendulum, having a mass m, is supported by a cart. The kinetic energy and potential energy for this system may be written as Eqs. (1) and (2), respectively:

$$T = \frac{1}{2} {m ( l \dot{θ} )}^{2} = \frac{1}{2} m {l}^{2} {\dot{θ}}^{2} \qquad ( 1 )$$

$$V = mgh = m g ( l - l cos ( θ ) ) \qquad ( 2 )$$

The length of the pendulum is l, acceleration from gravity is g, and the height of the mass is h at angle θ. The massless cart is kinematically constrained to move with a particular forcing function, ƒ(t). This force and its location with respect to the mass can be written as:

$$\vec{f} ( t ) = f ( t ) \vec{i} \qquad ( 3 )$$

$$\vec{r} = l sin ( θ ) \vec{i} + l cos ( θ ) \vec{j} \qquad ( 4 )$$

The generalized force may thus be written as:

$${Q}_{θ} ( t ) = \vec{f} ( t ) \cdot \frac{\partial \vec{r}}{\partial θ} = l cos ( θ ) f ( t ) \qquad ( 5 )$$

Assuming a Rayleigh dissipation function,

$$D = \frac{1}{2} {cml}^{2} {\dot{θ}}^{2} ,$$

Lagrange's equation can be used to find the equation of motion for the system as:

$$m {l}^{2} \ddot{θ} + {cml}^{2} \dot{θ} + mgl sin ( θ ) = l cos ( θ ) f ( t ) \qquad ( 6 )$$

By dividing by ml², the equation of motion can be written as:

$$\ddot{θ} + c \dot{θ} + {ω}_{n}^{2} sin ( θ ) = \frac{1}{m l} cos ( θ ) ( \hat{a} cos ( Ω t ) ) \qquad ( 7 )$$

Here, â is the forcing amplitude. Using x=θ and y=\dot{θ}, Eq. (7) can be written in state space as follow set of equations:

$$\begin{matrix}\dot{x} ( t ) = y ( t ) \\ \dot{y} ( t ) = - cy ( t ) - {ω}_{n}^{2} sin ( x ( t ) ) + A cos ( x ( t ) ) cos ( Ω t )\end{matrix} \qquad ( 8 )$$

### In Eq. (8),

$$A = \frac{\hat{a}}{m l} .$$

Now, an additional dynamic state, which adapts the natural frequency of the system to the forcing frequency, can be added:

$$\begin{matrix}\dot{x} ( t ) = y ( t ) \\ \dot{y} ( t ) = - cy ( t ) - {ω}^{2} ( t ) sin ( x ( t ) ) + A cos ( x ( t ) ) cos ( Ω t ) \\ \dot{ω} ( t ) = \frac{- A cos ( Ω t ) x ( t )}{\sqrt{{x}^{2} ( t ) + {y}^{2} ( t )}}\end{matrix} \qquad ( 9 )$$

As the linear natural frequency of the pendulum in FIG. 1 is given by

$${ω}_{n} = \sqrt{\frac{g}{l}} ,$$

the ω(t) state can be realized in an experiment by controlling the length of the pendulum, l. The \dot{ω} equation is similar to the frequency adaption state used for a Hopf adaptive frequency oscillator, although the y state in the numerator must be substituted for the x state.

### Numerical Results

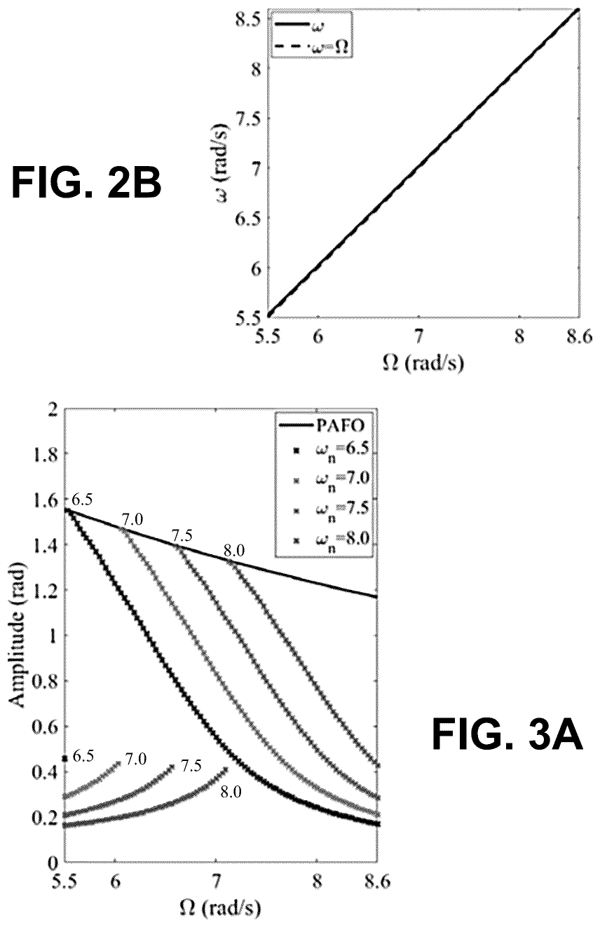

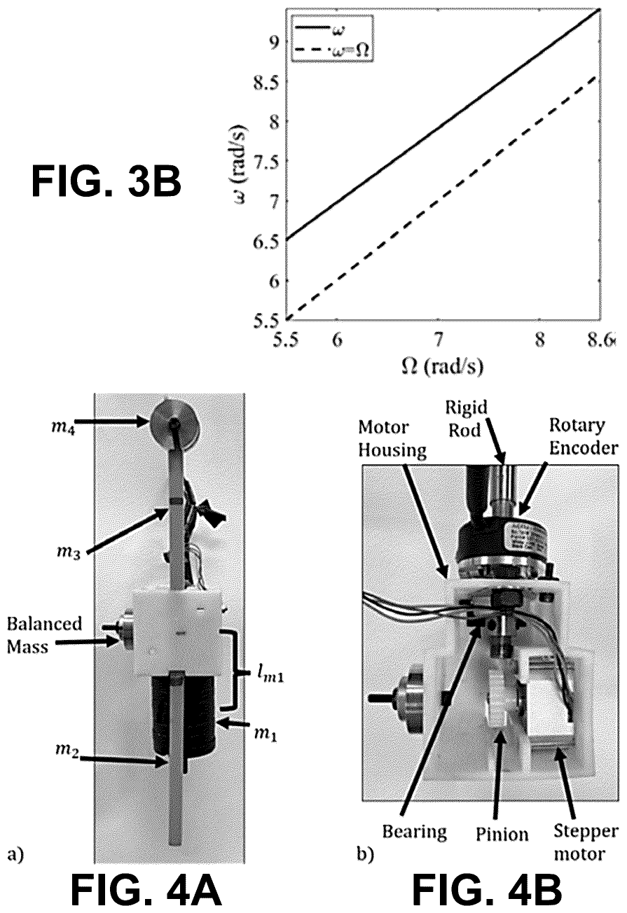

The set of Eqs. (8) and the set of Eqs. (9) were both simulated in MATLAB using ode45. The frequency response of several non-adaptive pendulums (Eq. (8)) with various static natural frequencies are shown in FIGS. 2A-2B and 3A-3B, along with the frequency learned and stored by the c) state. For small oscillations, the pendulum acts as a linear oscillator. For large oscillations, the pendulum acts as a softening Duffing oscillator.

In FIGS. 2A and 2B, the forcing amplitude was a small value (A=0.552). In this case, the pendulum responds as a linear oscillator. In FIG. 2A, the frequency response of the pendulum adaptive frequency oscillator is compared with the frequency response of the non-adaptive pendulum, for several values of ωₙ. For this simulation, c=0.45. For this reason, the ω state learns the external forcing frequency, Ω, with high accuracy, as can be seen in FIG. 2B. The dashed line is the “perfect” case, in which ω=Ω. Notice that the pendulum adaptive oscillator has the same amplitude as the non-adaptive pendulum only when the non-adaptive pendulum's amplitude is at a maximum.

In FIGS. 3A and 3B, the forcing amplitude was a larger value (A=5.52). In this case, the pendulum responds as a softening Duffing oscillator. In FIG. 3A, the frequency response of the pendulum adaptive frequency oscillator is compared with the frequency response of the non-adaptive pendulum, for several values of ωₙ. For this simulation, c=0.45. The pendulum's frequency response has a discontinuity, which is caused by multiple solutions of the analytical frequency response function given by Eqs. (9). Even though the pendulum's oscillations are nonlinear, the pendulum adaptive frequency oscillator still finds the maximal value of each of the non-adaptive pendulum's frequency amplitude response. However, for the non-adaptive pendulum, the peak no longer occurs at the natural frequency, but it instead occurs at a value below the natural frequency. This causes the c) state to learn a value that is higher than the forcing frequency; this offset causes the pendulum adaptive frequency oscillator to respond with an amplitude that is the maximum of the non-adaptive pendulum's frequency amplitude response. The c) state has an offset above the external forcing frequency as shown in FIG. 3B. This is caused by the hysteresis in the frequency amplitude response.

### Experimental Setup

In this section, the experimental prototype of the pendulum adaptive frequency oscillator is described. This mechanical prototype is described by the set of Eqs. (9), with the third equation describing the dynamics of the frequency adaptation. This third equation is realized in the mechanical prototype by first approximating the linear natural frequency of the pendulum, which is discussed below. The pendulum's rod length dynamically responds to learn the linear natural frequency. However, the pendulum has a nonlinear response at large forcing amplitudes. To account for this, the method of multiple scales is used to find the analytical solution of the pendulum, and it is shown that the pendulum responds as a Duffing oscillator. The hysteresis associated with the Duffing oscillator explains the offset present in the learning process when the forcing amplitude is large. This analytical response is also used to find the experimental parameters. Next, the experimental results of the mechanical pendulum adaptive frequency oscillator are shown.

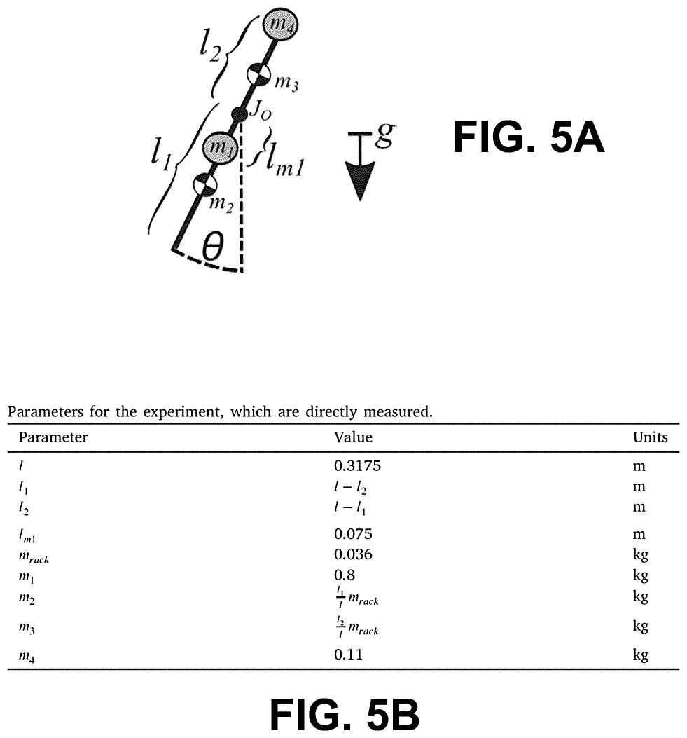

The experimental setup of an experimental pendulum adaptive frequency oscillator prototype is shown in FIGS. 4A and 4B. FIG. 4A is a side view illustrating how the balanced mass offsets the mass of the stepper motor. The masses and lengths can be compared to those labeled in the schematic diagram of the experimental pendulum adaptive frequency oscillator prototype depicted in FIG. 5A. This pendulum setup, similar to a metronome, allows a smaller amount of mass, m_{rack}+m₄, to be actuated with a stepper motor. The system rotates about the black dot. m₁ is the mass of an unmovable weight, which is offset by an amount lₘ₁ from the rotation point. m₂ is the mass of the lower portion of the rack, which has a length of l₁. m₃ is the mass of the upper portion of the rack, which has a length of l₂. m₄ is the mass at the top of the rack. This pendulum setup, similar to a metronome, allows a smaller mass, m₄ to be actuated with the stepper motor. FIG. 4B is a top view showing that the white motor housing, which was made 3D printed using Formlabs' Rigid resin. The rotary encoder measures the angular displacement of the pendulum. The stepper motor rotates a pinion, which moves the rack, modifies the pendulum's rod length. The rigid rod is connected to the cart.

For this prototype, the stepper motor is used to modify the length of the pendulum. To reduce the weight actuated by the stepper motor and to increase the range of frequencies that can be learned for the experimental pendulum, a metronome-inspired pendulum setup was designed. The angular displacement is measured by an encoder. The stepper motor rotates a pinion, which linearly moves the rack. The rack's weight changes the effective rod length of the pendulum. The pendulum's cart is attached to a linear bearing, and this cart is kinematically oscillated with a linkage that is driven by a motor. The forcing signal from this linkage is collected via a laser displacement sensor.

### Linear Natural Frequency Approximation

In this subsection, the linear natural frequency is derived for the experimental setup, when it is undergoing small oscillations. Some of the parameters for the experiment are measured directly, while some are calculated with a curve fit in the next subsection. Using the schematic shown in FIG. 5A, the kinetic and potential energy of the experimental system can be found. All of these quantities are measured and provided in the table of FIG. 5B, except for the quantity J₀.

The kinetic energy for the pendulum adaptive frequency oscillator is:

$$T = \frac{1}{2} ( {m}_{1} {l}_{m 1}^{2} + {m}_{2} \frac{{l}_{1}^{2}}{4} + {m}_{3} \frac{{l}_{2}^{2}}{4} + {m}_{4} {l}_{2}^{2} + {J}_{O} ) {\dot{θ}}^{2} \qquad ( 10 )$$

The potential energy for the pendulum adaptive frequency oscillator is:

$$V = {m}_{1} g ( {l}_{m 1} - {l}_{m 1} cos ( θ ) ) + {m}_{2} g ( \frac{{l}_{1}}{2} - \frac{{l}_{1}}{2} cos ( θ ) ) + {m}_{3} g ( \frac{{l}_{2}}{2} - \frac{{l}_{2}}{2} cos ( θ + π ) ) + {m}_{4} g ( {l}_{2} - {l}_{2} cos ( θ + π ) ) \qquad ( 11 )$$

Using a Taylor expansion, Eq. (11) simplifies to:

$$V \approx \frac{1}{2} ( {m}_{1} {gl}_{m 1} + {m}_{2} g \frac{{l}_{1}}{2} - {m}_{3} g \frac{{l}_{2}}{2} - {m}_{4} {gl}_{2} ) {θ}^{2} + {m}_{3} {gl}_{2} + 2 {m}_{4} {gl}_{2} \qquad ( 12 )$$

Using the Lagrange's equation, the experimental setup's equivalent mass, equivalent stiffness, and linear natural frequency are:

$$\begin{matrix}{m}_{e q} = {m}_{1} {l}_{m 1}^{2} + {m}_{2} \frac{{l}_{1}^{2}}{4} + {m}_{3} \frac{{l}_{2}^{2}}{4} + {m}_{4} {l}_{2}^{2} + {J}_{O} \\ {k}_{eq} = {m}_{1} {gl}_{m 1} + {m}_{2} g \frac{{l}_{1}}{2} - {m}_{3} g \frac{{l}_{2}}{2} - {m}_{4} g {l}_{2} \\ {ω}_{n} = \sqrt{\frac{{m}_{1} {gl}_{m 1} + {m}_{2} g \frac{{l}_{1}}{2} - {m}_{3} g \frac{{l}_{2}}{2} - {m}_{4} {gl}_{2}}{{m}_{1} {l}_{m 1}^{2} + {m}_{2} \frac{{l}_{1}^{2}}{4} + {m}_{3} \frac{{l}_{2}^{2}}{4} + {m}_{4} {l}_{2}^{2} + {J}_{O}}}\end{matrix} \qquad ( 13 )$$

This last equation provides the relationship between the rod length and the natural frequency, which will be utilized below. All of these quantities in Eq. (13) are known, except for the J₀. This term is affected by the rotational inertia of the bearing, motor housing, and encoder, and will be approximated.

### Method of Multiple Scales

In this subsection, the method of multiple scales is used to find the nonlinear frequency response of the pendulum undergoing large oscillations. Using this nonlinear frequency response to curve fit the experimental data, the remaining experimental parameters will be found in the next subsection.

Expanding sin(θ) and cos(θ) in a Taylor series and discarding the higher-order (≥2) terms while defining

$$\frac{\hat{a}}{m l} = A ,$$

then Eq. (7) becomes:

$$\ddot{θ} + c \dot{θ} + {ω}_{n}^{2} θ - \frac{{ω}_{n}^{2} {θ}^{3}}{6} = A ( 1 - \frac{{θ}^{2}}{2} ) cos ( Ω t ) \qquad ( 14 )$$

It should be noted that, when written in the form shown in Eq. (14), the nonlinear pendulum is a Duffing equation, with a softening nonlinear stiffness term. Introducing a book keeping term, ϵ, into Eq. (14), such that θ=\sqrt{ϵ}\hat{θ}, A=γ\sqrt{ϵ}Â and c=γĉ. Making these substitutions into Eq. (14):

$$\sqrt{ϵ} \ddot{\hat{θ}} + ϵ \hat{c} \sqrt{ϵ} \dot{\hat{θ}} + {ω}_{n}^{2} \sqrt{ϵ} \hat{θ} - \frac{{ω}_{n}^{2} ϵ \sqrt{ϵ} {\hat{θ}}^{3}}{6} = ϵ \sqrt{ϵ} \hat{A} ( 1 - \frac{ϵ {\hat{θ}}^{2}}{2} ) cos ( Ω t ) \qquad ( 15 )$$

Dividing this equation by \sqrt{ϵ}, the following expression is obtained:

$$\ddot{\hat{θ}} + ϵ \hat{c} \dot{\hat{θ}} + {ω}_{n}^{2} \hat{θ} - \frac{{ϵω}_{n}^{2} {\hat{θ}}^{3}}{6} = \hat{A} cos ( Ω t ) ( ϵ - \frac{{ϵ}^{2} {\hat{θ}}^{2}}{2} ) \qquad ( 16 )$$

The general solution is assumed to be of the following form:

$$\hat{θ} = {θ}_{0} + {ϵθ}_{1} \qquad ( 17 )$$

Several time scales, T₀, T₁, T₂, . . . , are introduced, where T₀=t, T₁=ϵt, T₂=ϵ²t, . . . . Thus, \hat{θ} is a function of the slow and fast time scales, and \hat{θ}(t,ϵ)=θ₀(T₀, T₁, T₂, . . . )+ϵθ₁(T₀, T₁, T₂, . . . )+ϵ²θ₂(T₀, T₁, T₂, . . . )+ . . . . Using the chain rule, the time derivatives become

$$\frac{d}{dt} = {D}_{0} + ϵ {D}_{1} - {ϵ}^{2} {D}_{2} , \frac{{d}^{2}}{{dt}^{2}} = {D}_{0}^{2} + 2 ϵ {D}_{0} {D}_{1} + {ϵ}^{2} ( {D}_{1}^{2} + 2 {D}_{0} {D}_{1} ) + … .$$

The general solution and the time derivatives are substituted back into Eq. (16), and, by gathering together the terms with the same powers of E and equating to zero, the following set of differential equations is obtained:

$${ϵ}^{0} : {D}_{0}^{2} {θ}_{0} + {ω}_{n}^{2} {θ}_{0} = 0 \qquad ( 18 )$$

$${ϵ}^{1} : {D}_{0}^{2} {θ}_{1} + {ω}_{n}^{2} {θ}_{1} = \hat{c} {D}_{0} {θ}_{0} - 2 {D}_{0} {D}_{1} {θ}_{0} + \hat{A} cos ( Ω t ) + \frac{{ω}_{n}^{2} {θ}_{0}^{3}}{6} \qquad ( 19 )$$

The solution of Eq. (18) can be written as:

$${θ}_{0} = αcos ( β + {T}_{0} ) \qquad ( 20 )$$

or in complex form as:

$${θ}_{0} = {Be}^{{iT}_{0}} + \overline{B} {e}^{- {iT}_{0}} \qquad ( 21 )$$

where α=α(T₁), β=β(T₁), B=B(T₁), B̅=B̅(T₁), and B̅ is the complex conjugate of B. B and B̅ can be expressed in their polar forms, shown as following:

$$\begin{matrix}B = \frac{1}{2} α {e}^{i β} \\ \overline{B} = \frac{1}{2} α {e}^{- i β}\end{matrix} \qquad ( 22 )$$

Substituting Eq. (22) into Eq. (19) results in the following expressions:

$${D}_{0}^{2} {θ}_{1} + {ω}_{n}^{2} {θ}_{1} = 2 i {ω}_{n} ( - \frac{1}{2} \hat{c} {Be}^{{iT}_{0} {ω}_{n}} + \frac{1}{2} \hat{c} \overline{B} {e}^{- {iT}_{0} {ω}_{n}} - {e}^{{iT}_{0} {ω}_{n}} {D}_{1} B + {e}^{- {iT}_{0} {ω}_{n}} {D}_{1} \overline{B} ) + \frac{1}{2} ( {B}^{2} {ω}_{n}^{2} \overline{B} {e}^{{iT}_{0} {ω}_{n}} + {\overline{B}}^{2} {ω}_{n}^{2} {Be}^{- {iT}_{0} {ω}_{n}} + \hat{A} {e}^{- {iT}_{0} Ω} + \hat{A} {e}^{{iT}_{0} Ω} ) + \frac{{ω}_{n}^{2}}{6} ( {B}^{3} {e}^{3 {iT}_{0} {ω}_{n}} + {\overline{B}}^{3} {e}^{- 3 {iT}_{0} {ω}_{n}} ) \qquad ( 23 )$$

where

$$\frac{1}{2} ( \hat{A} {e}^{- i {T}_{0} Ω} + \hat{A} {e}^{i {T}_{0} Ω} )$$

in the above equation is the complex form of the external forcing. Assuming that Ω=ωₙ+ϵσ and T₁=T₀ϵ, the resulting equation is given by:

$${D}_{0}^{2} {θ}_{1} + {ω}_{n}^{2} {θ}_{1} = 2 i {ω}_{n} ( - \frac{1}{2} \hat{c} {Be}^{{iT}_{0} {ω}_{n}} + \frac{1}{2} \hat{c} \overline{B} {e}^{- {iT}_{0} {ω}_{n}} - {e}^{{iT}_{0} {ω}_{n}} {D}_{1} B + {e}^{- {iT}_{0} {ω}_{n}} {D}_{1} \overline{B} ) + \frac{1}{2} ( {B}^{2} {ω}_{n}^{2} \overline{B} {e}^{{iT}_{0} {ω}_{n}} + {\overline{B}}^{2} {ω}_{n}^{2} {Be}^{- {iT}_{0} {ω}_{n}} ) + \frac{1}{2} ( \hat{A} {e}^{- {iT}_{0} {ω}_{n} + {iT}_{1} σ} + \hat{A} {e}^{{iT}_{0} {ω}_{n} + {iT}_{1} σ} ) + \frac{1}{6} ( {ω}_{n}^{2} {B}^{3} {e}^{i 3 {iT}_{0} {ω}_{n}} - {ω}_{n}^{2} {\overline{B}}^{3} {e}^{- i 3 {iT}_{0} {ω}_{n} )} \qquad ( 24 )$$

Equating the secular terms to zero, the following equation is obtained:

$$- i \hat{c} {ω}_{n} B - 2 i {ω}_{n} {D}_{1} B + \frac{1}{2} ( {B}^{2} \overline{B} {ω}_{n}^{2} + \hat{A} {e}^{{iT}_{1} σ} ) = 0 \qquad ( 25 )$$

Substituting the polar form of B and e^{iβ}=cos(β)+i sin(β) into Eq. (25), the solvability condition can be expressed as:

$$0 = \frac{1}{2} \hat{c} {ω}_{n} α - i {ω}_{n} {D}_{1} α + {ω}_{n} α {D}_{1} β + \frac{{α}^{3} {ω}_{n}^{2}}{16} + \frac{1}{2} ( \hat{A} cos ( {T}_{1} σ - β ) + i \hat{A} sin ( {T}_{1} σ - β ) ) \qquad ( 26 )$$

Eq. (26) can be separated into two different equations, which represent the real and imaginary parts, respectively. This can then be rearranged to obtain the following expressions for D₁α and D₁β:

$$\begin{matrix}{D}_{1} α = \frac{1}{2} c α + \frac{\hat{A} sin ( {T}_{1} σ - β )}{2 {ω}_{n}} \\ {D}_{1} β = - \frac{{α}^{2} {ω}_{n}}{16} - \frac{\hat{A} cos ( {T}_{1} σ - β )}{2 {ω}_{n} α}\end{matrix} \qquad ( 27 )$$

For γ=T₁σ−β, D₁γ=σ−D₁β. Thus, Eq. (27) becomes:

$$\begin{matrix}{D}_{1} α = \frac{1}{2} c α + \frac{\hat{A} cos ( γ )}{2 {ω}_{m}} \\ {D}_{1} γ = \frac{{α}^{2} {ω}_{n}}{16} + \frac{\hat{A} cos ( γ )}{2 {ω}_{n} α} + σ\end{matrix} \qquad ( 28 )$$

The system represented by Eq. (28) is a planar autonomous dynamical system. Setting ϵ=1, solving the fixed point (α₀, γ₀) solution, and rearranging the equation by using sin²γ+cos² γ=1 provides the frequency response function:

$${( c {ω}_{n} )}^{2} + {( \frac{{α}_{0}^{3} {ω}_{n}^{2}}{8} + 2 {σα}_{0} {ω}_{n} )}^{2} = {A}^{2} \qquad ( 29 )$$

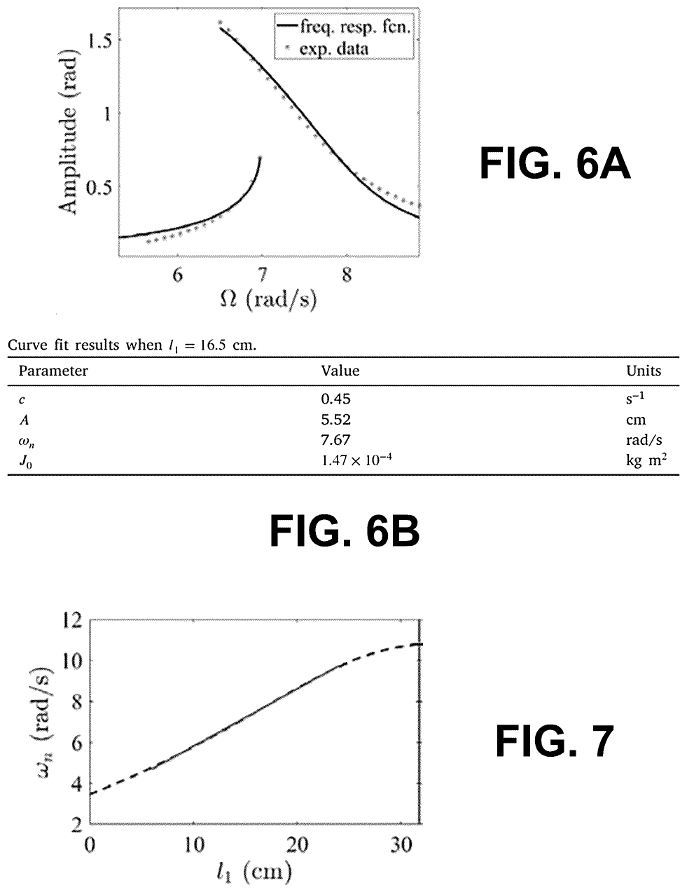

The frequency response function in Eq. (29) is plotted in FIG. 6A. For a non-adaptive pendulum with rod length set to l₁=16.5 cm, a frequency upsweep and downsweep was performed with the experiment; the asterisk markers are the prototype's amplitude response. This data was then used in a curve fit of Eq. (29). The resulting frequency response function is plotted as a solid black curve. It should be noted that Eq. (29) has multiple roots, and some frequencies have two stable amplitude responses. In the next subsection, this frequency response function will be used to approximate several of the remaining experimental parameters. Eq. (29) has multiple roots. In FIG. 6A, the stable roots are plotted for different values of Ω. A hysteresis region may be seen, in which there are two stable roots for a single value of Ω. There is an unstable root between these two stable roots, which is not shown.

### Experimental Parameters

Since this system is nonlinear, a curve fitting procedure was necessary to calculate the values of c and J₀, as these values cannot be directly measured in the experiment. By using the analytical frequency response curve found in Eq. (29), the rotational inertia, J₀, damping parameter, c, horizontal forcing amplitude, A, and a static linear natural frequency, ωₙ, can be calculated from a curve fit. It should be noted that the forcing amplitude is also included in this curve fit because the laser displacement data is noisy. For comparison, the amplitude from the laser sensor of the forcing amplitude is approximately 5.69 cm, which is 3% different than the curve fitted result.

A forcing frequency upsweep and downsweep, ranging from 5.5 (rad/s) to 9 (rad/s), was performed on the non-adaptive pendulum with a fixed rod length, such that l₁=16.5 cm. This data is plotted as asterisks in FIG. 6. This data was then used to curve fit the frequency response function given by the roots of Eq. (29) using MATLAB's lsqcurvefit. The resulting analytical frequency response curve is shown in FIG. 6. The parameters obtained from the curve fit are listed in the table of FIG. 6B. The natural frequency of this non-adaptive pendulum is calculated as ωₙ=7.67 (rad/s) from the curve fit. This value can then be substituted into Eq. (13) to find the J₀ value, which was calculated as J₀=1.47×10⁻⁴ (kg m2).

Using the value of J₀ that is found from the curve fit, the relationship between the system's natural frequency and the hanging length, l₁, can be derived using Eq. (13). This relationship between is depicted in FIG. 7. The relationship between the lower rack length, l₁, and the pendulum's linear natural frequency is depicted as a dashed curve. A portion of this curve has a linear relationship (depicted as a solid curve in FIG. 7), for lengths ranging from approximately 6<l₁<24. This linear relationship (as found from a curve fit), ωₙ(l₁)=0.28l₁+3.003, can be used to control the stepper motor.

### Experimental Implementation of Frequency Adaptation

The ω state given by Eq. (9) is implemented as follows. The laser displacement sensor measures the position of the periodic forcing of the experiment, while the encoder measures the angular position of the pendulum. The angular velocity is calculated by taking the numerical derivative (e.g.,

$$y ( i ) = \frac{x ( i ) - x ( i - 1 )}{Δ t} ,$$

for a sampling rate of 1/Δt). By using Euler's method, the ω state described in Eq. (9) can be re-written as:

$$ω ( i + 1 ) = ω ( i ) - \frac{kf ( i ) x ( i )}{\sqrt{{x}^{2} ( i ) + {y}^{2} - ( i )}} Δ t \qquad ( 30 )$$

In Eq. (30), i is an integer that corresponds to the ith sample in time. It should be noted that the time series does not need to be recorded, except for the previous angular displacement that is needed to calculate y(i). k is an arbitrary coupling constant that is set to 0.6 in the experimental results of the next section, ƒ(i) is the sensor measurement at time step i, x(i) is the angular displacement at time step i, and y(i) is the angular velocity at time step i. This ω state is used to calculate an incremental change in the rod length, Δl₁, by using the linear relationship shown in FIG. 7 (l₁=3.57ωₙ−10.71):

The stepper motor controls the length of the rod. The experimental sensor data collection, the calculation of Eqs. (30) and (31), and the control signal sent to the stepper motor are performed with an Arduino. It is worth noting that no filtering was used for any of the experimentally collected data.

### Experimental Results

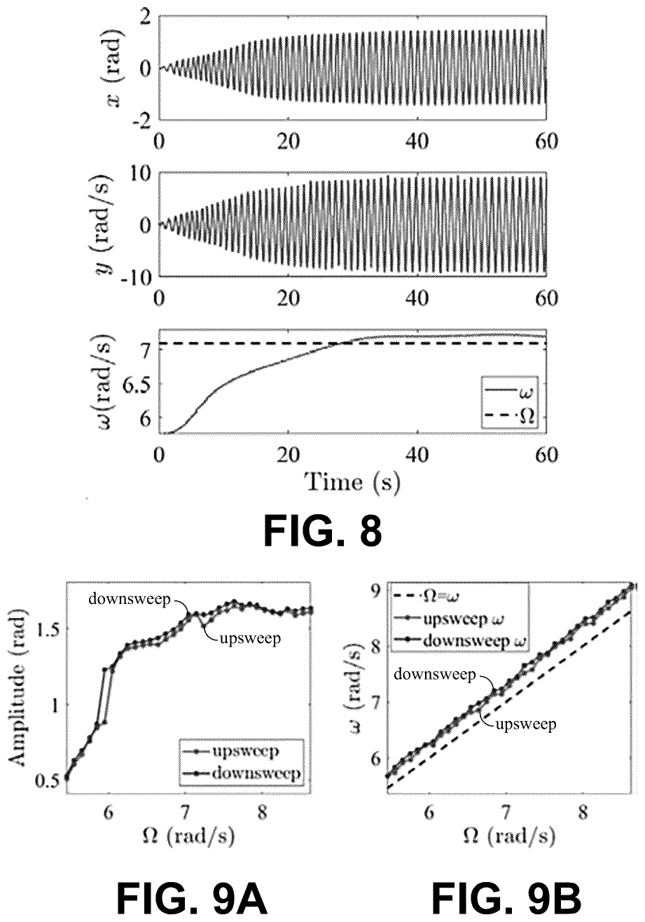

The pendulum adaptive frequency oscillator prototype was fabricated and tested. For a particular forcing frequency (Ω=7.1 rad/s), an example of a particular time history of the pendulum adaptive frequency oscillator is shown in FIG. 8. In this time history, the ω state starts far away from the forcing frequency, so the amplitudes of the x and y states are small. As the ω nears the forcing frequency, the amplitudes of the x and y states become large. The amplitude of the x and y states increase when the ω state has learned the resonance frequency.

A forcing frequency sweep ranging from 5.5 rad/s to 8.6 rad/s was used to measure the performance of the pendulum adaptive frequency oscillator prototype. The results are depicted in FIGS. 9A and 9B. The average of the c) state's steady state value is plotted for each forcing frequency, Ω. The line ω=Ω is plotted for reference. The pendulum adaptive frequency oscillator learns the input frequency with high accuracy. In this range, the ω state learns the forcing frequency with a percent error that is less than 5%, where the percent error is calculated as

$$\frac{〈 ω 〉 - Ω}{Ω} \times 100 \%$$

after the experiment has settled to a steady state response. Since the pendulum's oscillations were fairly large, the prototype has a Duffing-like response. This causes the ω state to have a positive offset as compared to the Ω value, which is similar to that seen in FIGS. 3A and 3B.

Comparing the frequency response obtained from the simulation (FIGS. 2A-2B and 3A-3B) and the experiment (FIGS. 9A-9B), it can be seen that the c) state responds in a qualitatively similar way in both the simulations and the experiments. However, the experiment of the pendulum adaptive frequency oscillator's amplitude falls considerably at approximately 6 rad/s, which is robust in the frequency sweep in the up and down directions. This effect may be attributed to a combination of the Duffing oscillator's hysteresis phenomenon and nonlinear damping in the experiment (e.g., wire effects, damping associated with the encoder, etc.).

To the inventors knowledge, this is the first time that a pendulum adaptive frequency oscillator has been proposed, fabricated, and tested. This system not only works in the linear regime, but it also has increased amplitudes for the nonlinear regime. At large amplitudes, the plastic frequency state converges to a value above the forcing frequency; this causes the pendulum to respond with the maximal amplitude of the non-adaptive pendulum. In this setup, no filtering was used for any of the experimental data collection. Other than the controller for the stepper motor, no control algorithms or signal processing techniques (such as fast Fourier transforms) are involved; the learning process is accomplished solely with the dynamical system itself. This pendulum adaptive frequency oscillator prototype can respond over a relatively large range of frequencies. Since vibratory energy harvesters are most efficient when the external vibrations align with a resonance, this pendulum adaptive frequency oscillator offers a viable architecture for a smart energy harvester.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A resonance tracking energy harvester, comprising:
a pendulum adaptive frequency oscillator comprising an adjustable pendulum rod; and
control circuitry configured to adjust a length of the adjustable pendulum rod in response to a sensed forcing frequency.

2. The resonance tracking energy harvester of claim 1, wherein the adjustable pendulum rod extends above a pivot point of the pendulum adaptive frequency oscillator.

3. The resonance tracking energy harvester of claim 2, wherein the pendulum adaptive frequency oscillator comprises an actuator configured to adjust the length of the adjustable pendulum rod above the pivot point.

4. The resonance tracking energy harvester of claim 3, wherein the actuator is a stepper motor configured to advance or retract the adjustable pendulum arm.

5. The resonance tracking energy harvester of claim 4, wherein the control circuitry comprises a stepper motor controller.

6. The resonance tracking energy harvester of claim 2, wherein the adjustable pendulum rod comprises a weight at a distal end above the pivot point.

7. The resonance tracking energy harvester of claim 1, wherein the pendulum adaptive frequency oscillator comprises a rotary encoder configured to measure angular displacement of the pendulum adaptive frequency oscillator.

8. The resonance tracking energy harvester of claim 1, wherein the length of the adjustable pendulum rod is adjusted for resonant operation at the sensed forcing frequency.

9. The resonance tracking energy harvester of claim 1, wherein the length of the adjustable pendulum rod is adjusted in response to a change in the sensed forcing frequency.

10. The resonance tracking energy harvester of claim 1, wherein oscillation of the pendulum adaptive frequency oscillator is converted to electrical energy.

11. The resonance tracking energy harvester of claim 10, wherein the electrical energy is harvested via one or more piezoelectric elements.

12. The resonance tracking energy harvester of claim 1, wherein a laser displacement sensor detects the sensed forcing frequency.

13. A method of resonance tracking energy harvesting, comprising:
sensing a forcing frequency applied to a pendulum adaptive frequency oscillator comprising an adjustable pendulum rod; and
adjusting a length of the adjustable pendulum rod in response to the sensed forcing frequency.

14. The method of claim 13, wherein the length of the adjustable pendulum rod is adjusted by an actuator.

15. The method of claim 14, wherein the actuator is a stepper motor configured to advance or retract the adjustable pendulum arm.

16. The method of claim 13, wherein adjusting the length of the adjustable pendulum rod comprises extending the adjustable pendulum rod above a pivot point of the pendulum adaptive frequency oscillator.

17. The method of claim 13, wherein the adjustable pendulum rod comprises a weight at a distal end above the pivot point.

18. The method of claim 13, comprising converting oscillation of the pendulum adaptive frequency oscillator to electrical energy.

19. The method of claim 13, comprising converting vibrational energy of the pendulum adaptive frequency oscillator to electrical energy.
